(19) United States
(12) Patent Application Publication
(10) Pub. No.: US 2019/0047137 A1
(43) Pub. Date: Feb. 14, 2019

(54) UTILITY TOOL BAG

(71) Applicant: Jerod Allen, Kansas City, KS (US)

(72) Inventor: Jerod Allen, Kansas City, KS (US)

(21) Appl. No.: 16/102,881

(22) Filed: Aug. 14, 2018

Related U.S. Application Data
(60) Provisional application No. 62/545,155, filed on Aug. 14, 2017.

(51) Int. Cl. B25H 3/00

(52) U.S. Cl. CPC B25H 3/00; A45C 3/00

(57) ABSTRACT

A utility tool bag includes a paddle clip attached to a flap that is hingedly attached to the top of the tool bag, the paddle clip configured to attach the tool bag to the clothing of a user. A main interior compartment includes numerous sub-compartments configured to receive and store a corresponding specific tool. A plurality of exterior pouches are similarly configured to receive and store corresponding specific tools. Hooks and utility rings on the external surfaces of the bag allow additional tools or equipment to be attached and removed by a user.

### CROSS-REFERENCE TO RELATED APPLICATIONS

This application claims the benefit of U.S. Provisional Patent Application No. 62/545,155, filed Aug. 14, 2017, the disclosure of which is hereby incorporated herein in its entirety by reference.

### BACKGROUND OF THE INVENTION

### Field of the Invention

The present invention relates generally to tool bags. More specifically, the invention relates to a utility tool bag having a paddle clip attached to a hingedly attached flap extending from the upper portion of the bag for securing the bag to the clothing of a wearer, with a specialized arrangement and configuration of pockets, compartments, flaps, and hooks to receive and hold tools related to a specific trade or occupation.

### Description of Related Art

Various types of tool bags are known in the art. Typical tool bags are general purpose, configured to hold a large variety of tools of varying sizes and shapes, but are note well-suited for storing and organizing specific sets of tools. A common tool bag includes a large main compartment into which numerous tools are placed, with a snap or zipper securing the contents inside. Some tool bags include outside pockets for inserting additional tools.

While known tool bags serve their general purpose, they are not ideal for storing specialized tools or for storing specific tools related to a specialized profession. Thus, the tools inside the main compartment of a general-purpose tool bag all share the same space and are not organized or compartmentalized. A user looking for a specific tool must rummage through the pile of tools in the main compartment to find the desired tool. In the case of smaller tools, or costly or precision tools, it is undesirable to simply toss the tool into a compartment with other heavier tools because of the risk of damage to the more fragile or precise tool. Thus, many users keep their precision tools separate, requiring them to remember the additional tools when going to a jobsite or requiring them to carry more than one tool bag or case.

Further, conventional tool bags typically include a top handle and/or a carrying strap so that a user can carry the bag to various locations. However, such a handle and strap arrangement is not conducive for use in situations where a user must climb ladders and structures, as the user's hands must be free to safely climb, or in situations where the user needs to use a tool but also keep the tool bag in close proximity.

Thus, it can be seen that there is a need in the art for an improved utility tool bag that provides for easy and secure wearing by a user, with secure storage of multiple tools without the drawbacks associated with conventional tool bags.

### SUMMARY OF THE INVENTION

The present invention is directed to a utility tool bag having a paddle clip attached to a hingedly movable flap extending upwardly from a top portion of the tool bag for securing the bag to the clothing of a wearer, with multiple storage compartments, storage pockets, and hooks or hangers for storing and protecting numerous tools required by a user in a specialized field of trade.

In one exemplary embodiment, the utility tool bag includes a hingedly attached top flap that pivots in relationship to the body of the bag. A paddle clip is attached to the outer surface of the top flap, so that the tine of the paddle clip may be inserted into a belt, pocket, waistband, or other receptacle on the clothing of a user. With the paddle clip thus securely attached, the bag hangs alongside the body of a wearer for easy access to contained tools. The hingedly attached flap allows the user to move and flex as necessary, with the tool bag staying close to the user's body. Thus, the user has immediate access to the tool bag, while his or her hands remain free to climb or use tools without having to hold or relinquish the tool bag.

In a further aspect, the utility tool bag is provided with compartmentalized storage pockets and pouches to store the specialized tools used in the field of building and home inspections. Thus, the utility tool bag includes pockets for specific specialized tools and equipment used by professionals in that field such as a laser measuring device, a scale, a tape measure, chalk, a camera, a phone, a pen, spare batteries, along with auxiliary pouches for additional items required for any specific job.

In one embodiment, the utility tool bag includes a main compartment coverable by a closable flap that is secured via an interlocking zipper fastener, with outer front, left, and right side pouches including a similar closable flap cover for each, preferably secured by Velcro® fasteners. The main compartment is subdivided into a series of smaller compartments and pouches, each configured to contain a specific tool or device (such as those listed above) within the pouch. Thus, every tool and piece of equipment has a specific storage area within the main compartment and/or within the left or right side pouches, so that each piece of equipment is stored securely and safely without directly contacting the other tools in the pouch and without the risk of damage that is likely in a general purpose tool bag having a large interior compartment storing all of the tools in direct contact.

In another embodiment, one or more hooks are attached to the exterior of the utility tool bag to allow a user to quickly and easily hang or attach additional equipment, such as a clipboard, or any device with a hanging loop, for easy access. The hooks are preferably one or more carabiner or J-hooks attached along the front or sides of the bag, in alternative embodiments different types of hooks may be used. In other embodiments the pouch includes sewn loops to which carabiner clips may be attached. In further embodiments, each corner of the utility bag includes a utility ring for securing tools.

The back side of the utility tool bag is preferably devoid of exterior pockets or hooks so that the bag can lie flat on a surface or can lie flat against the body of a user in the case where the utility tool bag is worn by the user.

### BRIEF DESCRIPTION OF THE DRAWINGS

FIG. 1 is a perspective view of a utility tool bag in accordance with an exemplary embodiment of the present invention.

FIG. 2 is a right-side view of the utility tool bag of FIG. 1.

FIG. 3 is a partial close-up view of the utility tool bag of FIG. 1 showing a paddle clip on the upper surface of a hingedly attached flap extending upwardly from the upper rear portion of the bag.

FIG. 4 is a partial close-up view of the lower front portion of the utility tool bag of FIG. 1 showing tool clips positioned on the front surface of the bag.

FIG. 5 is a partial close-up view of the interior lower surface of the hingedly attached flap.

FIG. 6 is an environmental view of the utility tool bag of FIG. 1 shown in use and worn by a user and populated with tools.

### DETAILED DESCRIPTION OF EXEMPLARY EMBODIMENTS

Various embodiments of the present invention are disclosed herein, it is to be understood that the disclosed embodiments are merely exemplary of the invention, which may be embodied in various forms. Thus, any specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology used in the following description is for convenience in reference only and is not limiting. For example, the words “vertically”, “horizontally”, “vertical”, “horizontal” and “upwardly”, “downwardly”, “upper”, “lower” all refer to the normal or nominal position of the item to which the reference is made. The words “inwardly” and “outwardly” refer to directions toward and away from, respectively, the geometric center of the embodiment being designated and parts thereof. The terminology used herein may include the words specifically mentioned, derivatives thereof and words of a similar import. It is further understood that terminology such as the aforementioned directional phrases may be used to describe exemplary embodiments of the utility tool bag as shown in the figures herein. This is for convenience only as it is understood that the exemplary embodiments of the utility tool bag may also be used horizontally, at an angle, or in an inverted position.

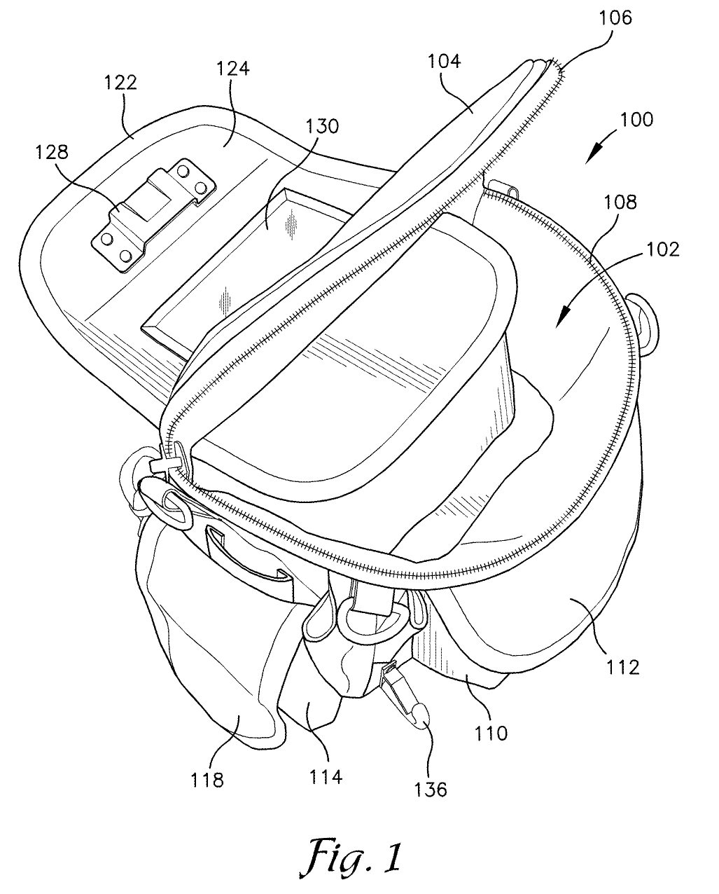

Looking to FIGS. 1 through 6, a utility tool bag in accordance with an exemplary embodiment of the present invention is referenced generally by the numeral 100. The utility tool bag includes a main compartment 102, defined by front, rear, side, and bottom panels integrally connected to form a generally semicircular shaped shell for holding various tools and equipment as is known in the art.

A lid 104 is hingedly attached at the upper rear edge of the main compartment 102, with the lid moveable between an open position (as depicted) in which the interior of the main compartment 102 is accessible by a user, and a closed position in which the lid 104 covers the main compartment 102.

An interlocking zipper slide fastener 106 on the outer perimeter of the lid 104 engages with a corresponding zipper slide fastener 108 along the upper semicircular perimeter of the main compartment 102 so that the lid 104 may be secured in a closed position to protect the contents of the interior of the main compartment 102.

A front pouch compartment 110 is attached to the outer front wall of the main compartment 102, with a flap closure 112 hingedly attached at the upper edge of the front pouch compartment 110, the flap closure 112 operable to fold down and over the pouch compartment 110 to secure tools within. Preferably, the flap closure 112 secures to the outer surface of the pouch compartment 110 with a Velcro® type fastening mechanism, although other securement devices known in the art, such as snaps or magnets, may likewise be employed.

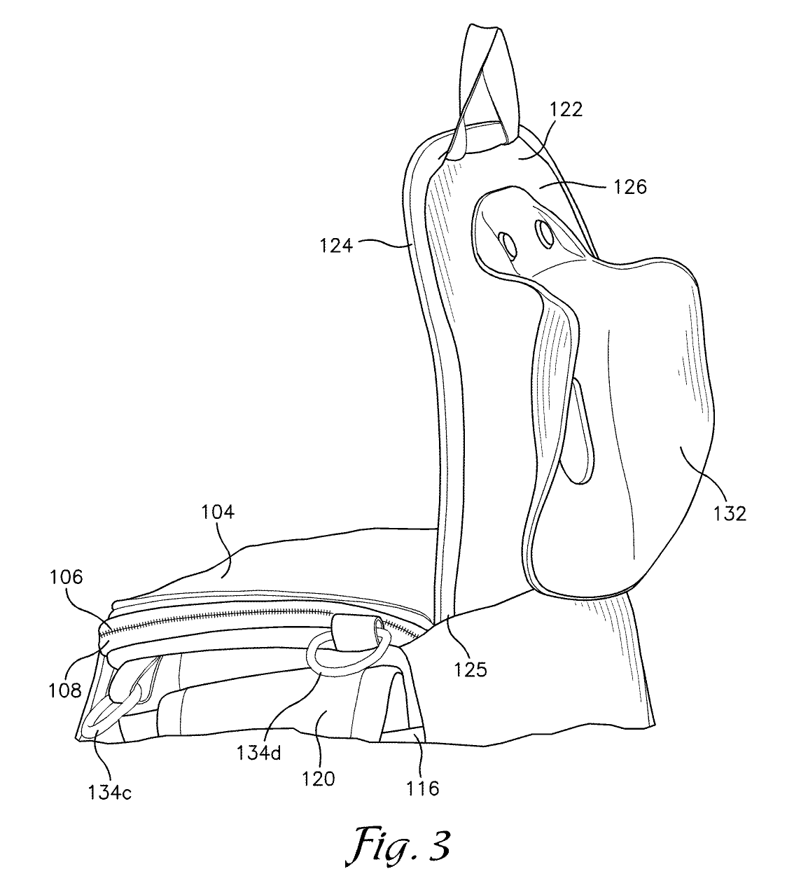

A right-end pouch compartment 114 is attached to the right side of the utility tool bag, with a left-end pouch compartment 116 similarly attached to the left side of the utility tool bag as seen in FIG. 3. Each of the right-end and left-end pouch compartments 114, 116 includes a corresponding flap cover 118, 120, which covers the corresponding pouch in a manner similar to that of the flap closure 112 covering the front pouch compartment 110.

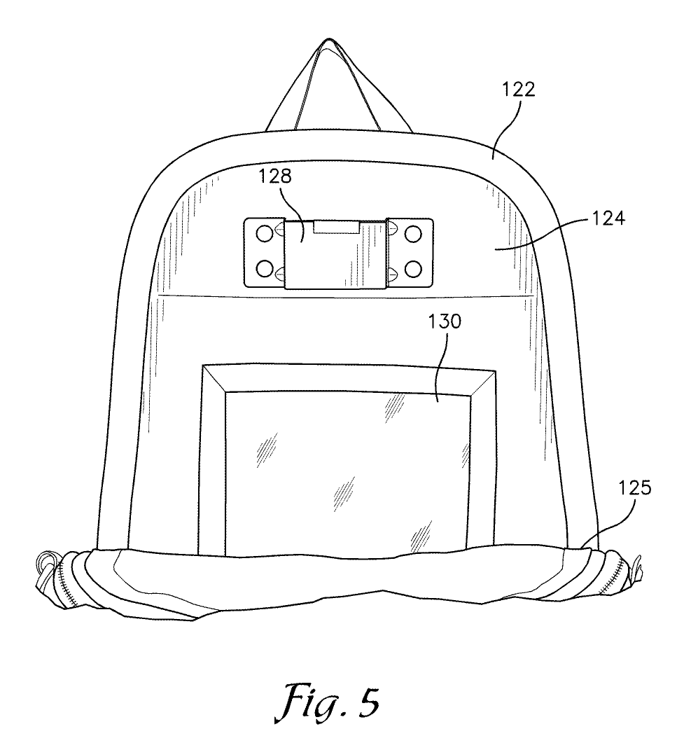

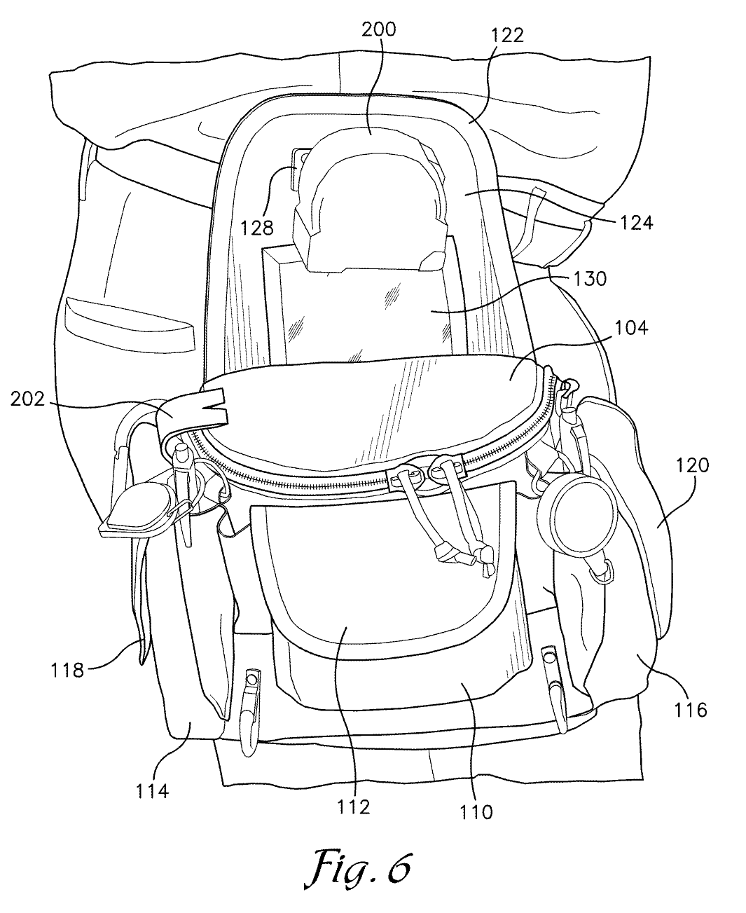

A flap 122 extends upwardly and outwardly from the rear portion of the bag, with the lower edge of the flap 122 hingedly attached in a manner similar to that of the lid 104. The inner surface 124 of the flap includes an attachment clip configured to receive and secure a belt clip portion of a tape measure or other tool. A document pouch 130 having a clear plastic cover is configured to receive a business card or other identification or informational document. As seen in FIGS. 5 and 6, in use, the flap 122 extends upwardly, prominently displaying the business card as the tool bag is worn by a user.

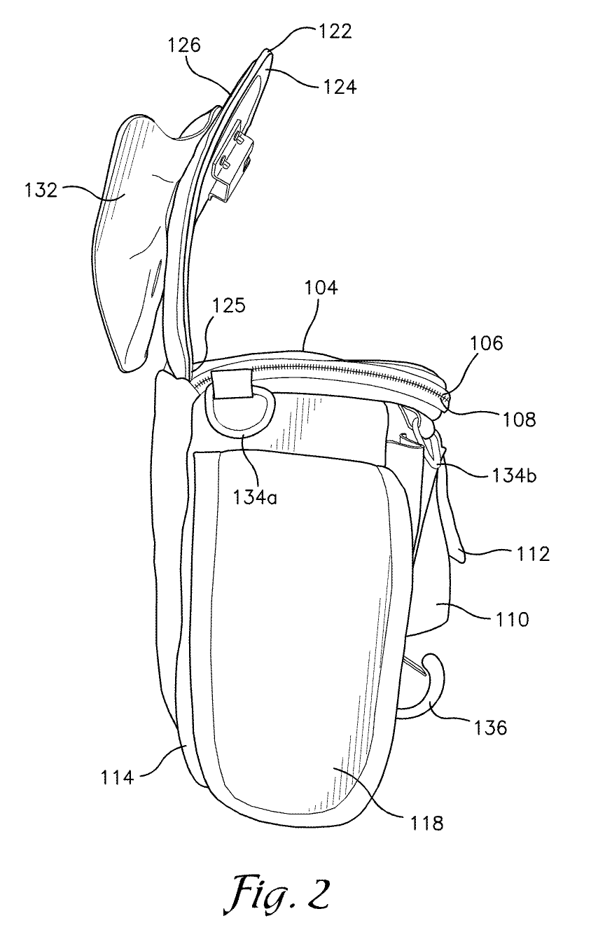

Looking to FIGS. 2 and 3, a paddle clip 132 comprising an elongated tine portion is attached to the outer surface 126 of the flap 122, with the tine extending downwardly from the distal end of the flap 122. The tine is configured to fit within a receptacle on the clothing of a wearer, such as in a pocket, over a belt, or in a waistband, so as to secure the tool bag to the wearer. As seen in FIG. 6, with the paddle clip thus secured in a wearer's clothing, the tool bag hangs against the body of the wearer, with attached tools, such as a tape measure 200 or pry bar 202 readily accessible by the wearer. As can also be seen in FIG. 6, the main compartment is likewise readily accessible by simply opening the lid 104.

Looking to FIGS. 2 and 3, a series of utility rings 134a, 134b, 134c, 134d are attached, one at each upper corner of the tool bag. The rings are configured to allow attachment of tools having clips, or for insertion of elongated tools.

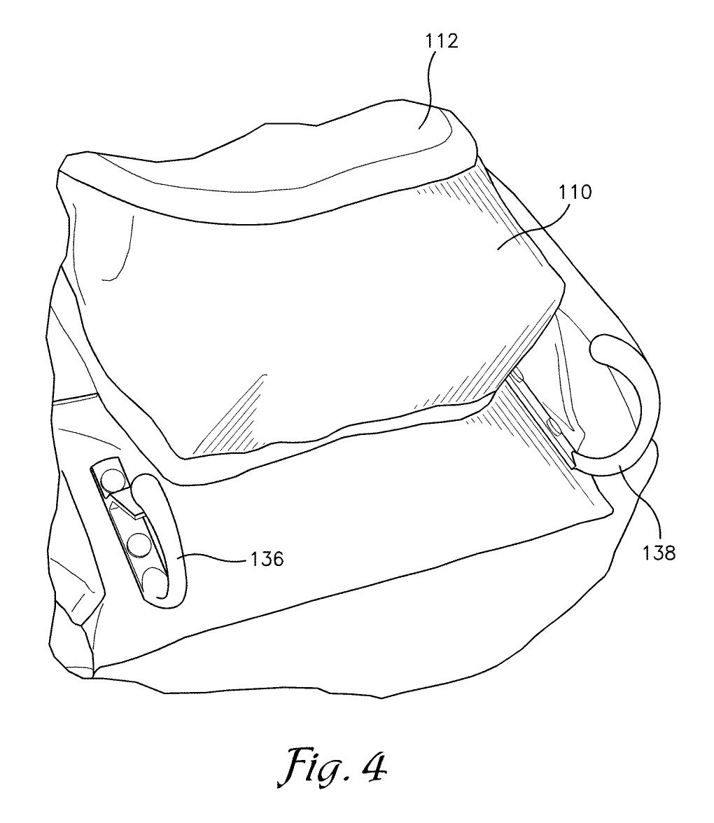

Turning to FIG. 4, a carabiner clip 136 and J-hook are attached to the lower portion of the outer surface of the front panel of the tool bag for additional tool attachment.

Thus, as shown in FIG. 6, with the tool bag worn by a user, i.e., with the paddle clip attached to a user's clothing, the bag is secured to the user and extends down the side of the user's body. In that position, the user has immediate access to tools secured in the front and outer pockets, tools secured to the clip or hook on the front surface, and to tools secured to the utility rings around the upper perimeter of the tool bag. In addition, the user has easy access to the inner compartment of the tool bag by simply opening the lid. All the while, the user's hands are free for climbing or manipulating tools.

Most preferably, the utility tool bag is formed from a durable, flexible, cloth-like material, such as cloth, canvas, or woven nylon. Other materials may also be used, such as waterproof vinyl, depending on the durability and properties of the material desired by the user. These and other variations are within the scope of the present invention.

Preferably, the interior main compartment 102 includes pockets and sub-compartments configured to receive, hold, and secure various specialized tools. For example, specific specialized tools and equipment used by professionals in the field of home and building inspection may include a laser measuring device, a scale, a tape measure, chalk, a camera, a phone, a pen, and spare batteries, thus the main compartment includes specific sub-compartments to contain each of those specialized tools.

As can be seen, the utility tool bag of the present invention thus provides a utility storage bag that can be attached to the clothing of a wearer, leaving the user's hands free for climbing or using tools. The tool bag includes multiple storage compartments, each compartment configured to receive a specific specialized tool and to prevent the multiple tools from coming into contact with each other, thus avoiding damage to the tools.

Preferably, the utility tool bag of the present invention includes compartmentalized storage pockets and pouches to store the specialized tools used in the field of building and home inspections. Thus, the utility tool bag of the exemplary embodiments includes pockets for specific specialized tools and equipment used by professionals in that field such as a laser measuring device, a scale, a tape measure, chalk, a camera, a phone, a pen, spare batteries, along with auxiliary pouches for additional items required for any specific job.

It should be understood that other configurations of the utility tool bag of the present invention are envisioned, and that utility tool bags designed to hold tools specific to any particular trade or profession may be configured, and are within the scope of the present invention. For example, a utility tool bag directed to electrical diagnostics may include specific compartments for tools applicable to that trade, including compartments for a multimeter, a voltage tester, test leads, fuses, and the like. Thus, the utility tool bag of the present invention may be adapted beyond the specific embodiments depicted and described herein.

As described, the utility tool bag of the present invention overcomes the drawbacks of conventional tool bags that require a user to secure the bag using a handle or shoulder strap, and the drawbacks of single compartment tool bags where tools are all stored in a single large container.

The main compartment of the utility tool bag of the present invention is subdivided into a series of smaller compartments and pouches, each configured to contain a specific tool or device within the pouch. Thus, each tool has a specific storage area within the main compartment and/or within the front, left or right side pouches, so that each piece of equipment is stored securely and safely without directly contacting the other tools in the pouch and without the risk of damage that is likely in a general purpose tool bag having a large interior compartment storing all of the tools in direct contact.

The hooks or carabiner clips on the exterior surfaces of the utility tool bag of the present invention allow a user to quickly attach and remove additional equipment, such as a clipboard, as necessary, or to attach any tool or equipment that is too large for storage within any of the pre-defined pouches or compartments.

The flat back and bottom of the utility tool bag allow it to be placed securely on a surface, or to lie against the body of a user in the case of wearing the utility tool bag attached to a belt or otherwise clipped to the clothing of a user.

It should be understood that while certain forms and embodiments have been illustrated and described herein, the present invention is not to be limited to the specific forms or arrangement of parts described and shown, and that the various features described may be combined in ways other than those specifically described without departing from the scope of the present invention. The terms “substantially”, “generally”, “approximately”, or any other qualifying term as used herein may be applied to modify any quantitative representation which could permissibly vary without resulting in a change to the basic function to which it is related.

What is claimed is:

1. A utility tool bag for carrying tools used by a technician or professional, comprising:
a plurality of panels connected to define an open main interior compartment for storing tools;
a lid hingedly attached to an upper portion of at least one of the panels, the lid configured to cover the open main interior compartment;
a flap hingedly attached to an upper portion of at least one of the panels; and
a paddle clip attached to the flap, the paddle clip configured to attach to the clothing of a wearer to secure the tool bag such that it extends alongside of the wearer's body.

2. The utility tool bag of claim 1, wherein the paddle clip comprises an elongated tine attached at a first end to the flap with an open second end extending downwardly away from the attached first end.

3. The utility tool bag of claim 1, wherein the open main interior compartment comprises a plurality of pockets.

4. The utility tool bag of claim 1, further comprising a plurality of hooks attached to an outer surface of the tool bag.

5. The utility tool bag of claim 4, wherein the plurality of hooks comprises carabiner clips, J-hooks, and combinations thereof.

6. The utility tool bag of claim 1, further comprising a plurality of utility rings attached to an upper portion of the plurality of panels.

7. A utility tool bag, comprising:
tine extending downwardly from one or more attachment hooks comprises at least one carabiner clip.
